(19) United States
(12) Patent Application Publication
(10) Pub. No.: US 2024/0174849 A1
(43) Pub. Date: May 30, 2024

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW)

(73) Assignee: NAN YA PLASTICS CORPORATION, TAIPEI (TW)

(21) Appl. No.: 18/071,629

(22) Filed: Nov. 30, 2022

(30) Foreign Application Priority Data
Oct. 27, 2022 (TW) 111140860

(51) Int. Cl. C08L 47/00; C08J 5/24

(52) U.S. Cl. CPC C08L 47/00; C08J 5/244; C08J 2347/00; C08J 2471/12

(57) ABSTRACT

A resin composition is provided, which includes a novel low-dielectric resin, a cross-linking agent, a polyphenylene ether resin, a halogen-free flame retardant, a spherical silica, and a siloxane coupling agent. The novel low-dielectric resin has a styrene proportion of 10% to 40%, a divinylbenzene proportion of 10% to 40%, and an ethylene proportion of 10% to 20%, which may effectively reduce the dissipation factor of the resin composition, and achieve the electrical specification of low dielectric.

### CROSS-REFERENCE TO RELATED APPLICATION

This application claims the priority benefit of Taiwan application serial no. 111140860, filed on Oct. 27, 2022. The entirety of the above-mentioned patent application is hereby incorporated by reference herein and made a part of this specification.

### BACKGROUND

### Technical Field

The disclosure relates to a low-dielectric resin, and particularly, to a low-dielectric resin composition.

### Description of Related Art

In recent years, with the development of 5G communication, copper clad laminate materials have been developed towards the goal of lower dielectric (low-k) properties. The current dielectric constant (Dk) of the substrate is about 3.2 to 5.0, which is not conducive to the application of high frequency and fast transmission in the future. In the current low-dielectric formula, a certain proportion of liquid rubber is added to reduce the electrical properties, but it still cannot achieve the electrical specification of ultra-low-dielectric (for example, dissipation factor (DO of less than 0.0015). In addition, the addition of a large amount of liquid rubber may easily cause phase separation between the resins, and a deterioration in fluidity and fillability, thereby resulting in a decrease in the overall processability.

Based on the above, a low-dielectric resin composition has been developed to reduce the dielectric loss while maintaining fluidity and fillability of the resin composition at the same time, so as to achieve the electrical specification of ultra-low-dielectric, which has become an urgent objective for those skilled in the art.

### SUMMARY

The disclosure provides a resin composition, which may reduce dielectric loss while maintaining fluidity and fillability at the same time, so as to achieve the electrical specification of low-dielectric.

A resin composition of the disclosure includes a novel low-dielectric resin, a cross-linking agent, a polyphenylene ether resin, a halogen-free flame retardant, a spherical silica, and a siloxane coupling agent. The novel low-dielectric resin has a styrene proportion of 10% to 40%, a divinylbenzene proportion of 10% to 40%, and an ethylene proportion of 10% to 20%.

In an embodiment of the disclosure, an addition amount of the novel low-dielectric resin is 10 wt % to 40 wt %, an addition amount of the cross-linking agent is 5 wt % to 25 wt %, an addition amount of the polyphenylene ether resin is 40 wt % to 60 wt %, and an addition amount of the spherical silica is 20 wt % to 50 wt %, based on a total weight of the above-mentioned resin composition.

In an embodiment of the disclosure, an addition amount of the halogen-free flame retardant is 20 phr to 50 phr, based on the total weight of the above-mentioned resin composition.

In an embodiment of the disclosure, an addition amount of the siloxane coupling agent is 0.1 phr to 5 phr, based on the total weight of the above-mentioned resin composition.

In an embodiment of the disclosure, a number average molecular weight of the above-mentioned novel low-dielectric resin is 4500 to 6000.

In an embodiment of the disclosure, the above-mentioned resin composition further includes a SBS resin. The SBS resin has a styrene proportion of 10% to 40%, a 1,2 vinyl proportion of 60% to 90%, and a 1,4 vinyl proportion of 10% to 30%.

In an embodiment of the disclosure, an addition amount of the SBS resin is 10 wt % to 40 wt %, based on the total weight of the above-mentioned resin composition.

In an embodiment of the disclosure, the above-mentioned SBS resin has a weight average molecular weight of 3500 to 5500.

In an embodiment of the disclosure, the electrical specification of the above-mentioned resin composition has a dielectric constant of 3.02 to 3.04, and a dissipation factor of less than 0.0018.

In an embodiment of the disclosure, the electrical specification of the above-mentioned resin composition has a dielectric constant of 3.0 to 3.1, and a dissipation factor of less than 0.0015.

Based on the above, by using the novel low-dielectric resin instead of liquid rubber, the resin composition of the disclosure may effectively reduce the dissipation factor and/or the dielectric constant of the resin composition, and achieve the electrical specification of low-dielectric while maintaining fluidity and fillability of the resin composition at the same time.

### DESCRIPTION OF THE EMBODIMENTS

Hereinafter, embodiments of the disclosure are described in detail. However, these embodiments are exemplary, and the disclosure is not limited hereto.

As used herein, a range represented by “one numerical value to another numerical value” is a general representation which avoids listing all the numerical values in the range in the specification. Therefore, the recitation of a particular numerical range includes any numerical value within that numerical range as well as a smaller numerical range defined by any numerical value within that numerical range, as is the case with any numerical value and a smaller numerical range thereof in the specification.

A resin composition of the disclosure includes a novel low-dielectric resin, a cross-linking agent, a polyphenylene ether resin, a halogen-free flame retardant, a spherical silica, and a siloxane coupling agent. Hereinafter, the above-mentioned various components are described in detail.

### Novel Low-Dielectric Resin

In the embodiment, the novel low-dielectric resin has a styrene proportion of 10% to 40%, a divinylbenzene proportion of 10% to 40%, and an ethylene proportion of 10% to 20%. A number average molecular weight (Mn) of the novel low-dielectric resin is about 4500 to 6000. In some embodiments, an addition amount of the novel low-dielectric resin is, for example, 10 wt % to 40 wt %, based on a total weight of the resin composition, and preferably, an addition amount of the novel low-dielectric resin is, for example, 30 wt %, to 38 wt %. By using a novel low-dielectric resin instead of liquid rubber, the dissipation factor and/or the dielectric constant of the resin composition may be effectively reduced to achieve the electrical specification of low-dielectric, while fluidity and fillability of the resin composition are maintained and no phase separation occurs between the resins at the same time.

### SBS Resin

In the embodiment, the SBS resin has a styrene proportion of 10% to 40%, a 1,2 vinyl proportion of 60% to 90%, and a 1,4 vinyl proportion of 10% to 30%. The SBS resin has a weight average molecular weight (MW) of about 3500 to 5500. An addition amount of the SBS resin is, for example, 0 wt % to 35 wt %, based on the total weight of the resin composition. By using SBS resin instead of liquid rubber, the phase separation between the resins and fluidity and fillability are improved, thereby enhancing the overall processability while maintaining low-dielectric properties at the same time.

### Cross-Linking Agent

In the embodiment, the cross-linking agent is used to increase the degree of cross-linking of a thermosetting resin and adjust rigidity and toughness of a substrate and the processability. The type of use may be a 1,3,5-triallyl cyanurate (TAC), a triallyl isocyanurate (TAIL), a trimethallyl isocyanurate (TMAIC), one or more combinations of a diallyl phthalate, a divinylbenzene, or a 1,2,4-triallyl trimellitate. An addition amount of the cross-linking agent is, for example, 5 wt % to 25 wt %, based on the total weight of the resin composition.

### Polyphenylene Ether (PPE) Resin

In the embodiment, the polyphenylene ether resin is a thermosetting polyphenylene ether resin, and is a composition having a styrene-type polyphenylene ether and an acrylic-type polyphenylene ether at the end groups. An addition amount of the polyphenylene ether resin is, for example, 40 wt % to 60 wt %, based on the total weight of the resin composition.

For example, the structure of the styrene-type polyphenylene ether is shown in Structural formula (A):

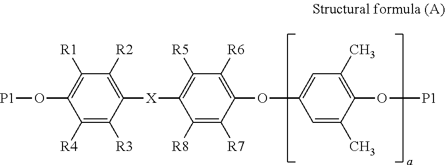

R1-R8 may be an allyl group, a hydrogen group, or a C1-C6 alkyl group, or one or more selected from the above-mentioned groups. X may be 0 (oxygen atom),

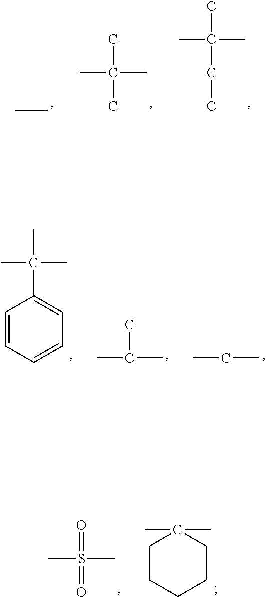

P1 is a styrene,

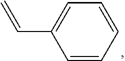

and a is an integer from 1 to 99.

The structure of the acrylic-type polyphenylene ether is shown in Structural formula (B):

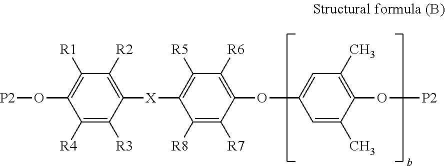

R1-R8 may be an ally group, a hydrogen group, or a C1-C6 alkyl group, or one or more selected from the above-mentioned groups. X may be: 0 (oxygen atom),

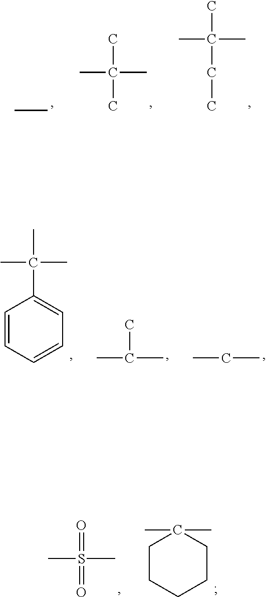

### P2 is

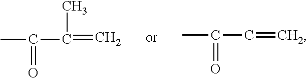

and b is an integer from 1 to 99.

Specific examples of the polyphenylene ether resin include, but are not limited to, a bishydroxypolyphenylene ether resin (such as SA-90, available from Sabic Corpoproportionn), a vinyl benzyl polyphenylene ether resin (such as OPE-2st, available from Mitsubishi Gas Chemical Co.), a methacrylate polyphenylene ether resin (such as SA-9000, available from Sabic), a vinyl benzyl modified bisphenol A polyphenylene ether resin, or a vinyl extended chain saw phenylene ether resin. The aforementioned polyphenylene ether is preferably a vinyl polyphenylene ether.

### Halogen-Free Flame Retardant

In the embodiment, specific examples of the halogen-free flame retardant may be a phosphorus-based flame retardant which may be selected from phosphate esters, such as: a triphenyl phosphate (TPP), a resorcinol diphosphate (RDP), a bis Phenol A bis(diphenyl) phosphate (BPAPP), a bisphenol A bis(dimethyl) phosphate (BBC), a resorcinol diphosphate (CR-733S), or a resorcinol-bis(di -2,6-dimethylphenyl phosphate) (PX-200); may be selected from phosphazenes, such as: a polydi(phenoxy)phosphazene (SPB-100); an ammonium polyphosphate, a melamine phosphate (MPP, namely melamine polyphosphate), or a melamine cyanurate; may be selected from one or more combinations of flame retardants such as a DOPO-type, such as a DOPO (such as Structural formula (C)), a DOPO-HQ (such as Structural formula (D)), a double DOPO derived structure (such as Structural formula €), etc.; or an aluminum-containing hypophosphite lipid (such as Structural formula (F)). An addition amount of the halogen-free flame retardant is, for example, 20 phr to 50 phr.

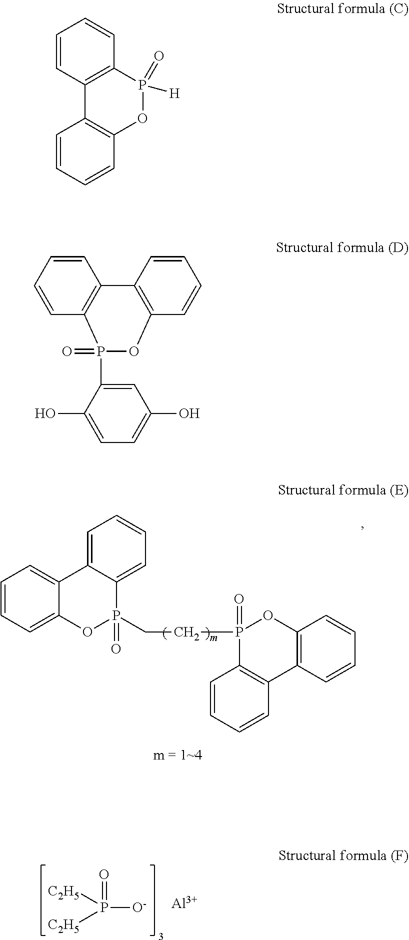

### Spherical Silica

In the embodiment, the spherical silica may preferably be prepared by a synthetic method so as to reduce the electrical properties and maintain fluidity and fillability. The spherical silica has a surface modification of an acrylic or a vinyl, with a purity of about 99.0% or above, and an average particle size D50 of about 2.0 μm to 3.0 μm. An addition amount of the spherical silica is, for example, 20 wt % to 50 wt %, based on the total weight of the resin composition.

### Siloxane Coupling Agent

In the embodiment, the siloxane coupling agent may include, but is not limited to, a siloxane. In addition, according to the type of functional group, it may be divided into an amino silane compound, an epoxide silane compound, a vinyl silane compound, an ester silane compound, a hydroxyl silane compound, an isocyanate silane compound, a methacryloxysilane compound, and an acryloxysilane compound. An amount of the siloxane coupling agent is, for example, 0.1 phr to 5 phr.

It should be noted that the resin composition of the disclosure may be processed into a prepreg and a copper foil substrate (CCL) according to actual design requirements. Therefore, the prepreg and the copper foil substrate produced by using the resin composition of the disclosure also has a better reliability (may maintain the required electrical properties). In some preferred embodiments, the dielectric constant of the substrate (or the prepreg) produced by the resin composition is about 3.0 to 3.1, and the dissipation factor is less than about 0.0015, which achieves the electrical specification of ultra-low-dielectric.

Hereinafter, the above-mentioned resin composition of the disclosure is described in detail by means of experimental examples. However, the following experimental examples are not intended to limit the disclosure.

### Experimental Example

In order to prove that the novel low-dielectric resin provided by the disclosure may effectively reduce the dissipation factor and/or dielectric constant of the resin composition to achieve the electrical specification of low-dielectric, while fluidity and fillability of the resin composition is maintained and no phase separation occurs between the resins at the same time, the following is an experimental example.

### <Preparation of Resin Composition>

The resin composition shown in Table 1 (including: Comparative Example 1, Example 1, Example 2, and Example 3) was mixed with toluene to form a varnish of a thermosetting resin composition, and the above-mentioned varnish was impregnated with a glass fiber cloth at room temperature (Nan Ya Plastic Company, cloth type 1078LD), and then dried at 170° C. (an impregnation machine) for a few minutes to obtain a prepreg with a resin content of 79 wt %. Finally, 4 pieces of prepregs were stacked on top of each other between two copper foils with thicknesses of 35 μm, kept at a constant temperature for 20 minutes under the pressure of 25 kg/cm2 and the temperature of 85° C. heated to 210° C. again at a heating rate of 3 t/min, kept at the constant temperature again for 120 minutes, and then slowly cooled to 130° C. to obtain the copper foil substrate with a thickness of 0.59 mm, which was evaluated for various properties.

### <Evaluation Method>

The copper foil substrates produced in the respective examples and comparative examples were evaluated according to the following methods, and the results are shown in Table 1.
(1) The glass transition temperature (° C.) was tested with a dynamic mechanical analyzer (DMA).
(2) Water absorption (%): After the sample was heated in a pressure cooker at 120° C. and 2 atm for 120 minutes, the weight change before and after heating was calculated.
(3) Solder heat resistance at 288° C. (seconds): The sample was heated in a pressure cooker at 120° C. and 2atm for 120 minutes, and then immersed in a solder furnace at 288° C., and the time required for the sample to explode and delaminate was recorded.
(4) Dielectric constant Dk: The dielectric constant Dk at a frequency of 10 GHz was tested with a dielectric analyzer HP Agilent E4991A.
(5) Dissipation factor Df: The dissipation factor Df at a frequency of 10 GHz was tested with a dielectric analyzer HP Agilent E4991A.
(6) Rate of resin fluidity: A press at 170° C. plus or minus 2.8° C. was used to depress with 200 PSI plus or minus 25 PSI for 10 minutes. After fusion and cooling, a disc was punched out, where the weight of the disc was precisely weighed, and the outflow of the resin was calculated.
(7) Resin phase separation (Slice analysis):
   Step 1: The copper foil substrate was cut into a size of 1cm*1cm, and placed into a mold for resin grouting.
   Step 2: After the resin was completely dried and hardened, the sample was ground and polished.
   Step 3: A high-resolution microscope such as an OM/SEM was used to analyze the sample to confirm whether there was a resin phase separation inside the sample.

### <Evaluation Result>

TABLE 1
Formula proportions and evaluation of properties of Comparative Example 1 and Examples 1 to 3

| | | Comparative Example 1 | Example 1 | Example 2 | Example 3 |
|---|---|---|---|---|---|
| Formula | PPE resin (%) | 50 | 50 | 50 | 50 |
| proportion | SBS resin (%) | 35 | 23 | 11 | — |
| | Novel low dielectric resin (%) | — | 12 | 24 | 35 |
| | Cross-linking agent (%) | 15 | 15 | 15 | 15 |
| | Halogen-free flame retardant (phr) | 30 | 30 | 30 | 30 |
| | Synthetic silica (%) | 40 | 40 | 40 | 40 |
| | Peroxide (phr) | 1 | 1 | 1 | 1 |
| | Siloxane coupling agent (phr) | 0.5 | 0.5 | 0.5 | 0.5 |

| | | | | |
|---|---|---|---|---|
| B-stage curing temperature (° C.) | 130 | 130 | 130 | 130 |
| Glass transition temperature (° C.) | 205 | 202 | 201 | 200 |
| Water absorption (PCT ½ hour) (%) | 0.18 | 0.18 | 0.17 | 0.15 |
| Heat resistance (PCT ½ hour) | OK | OK | OK | OK |
| Water absorption (PCT 2 hours) (%) | 0.24 | 0.23 | 0.23 | 0.21 |
| Heat resistance (PCT 2 hours) | OK | OK | OK | OK |
| Dielectric constant Dk | 3.06 | 3.04 | 3.03 | 3.01 |
| (measured at a frequency of 10 GHz) | | | | |
| Dissipation factor Df | 0.0018 | 0.0017 | 0.0016 | 0.0014 |
| (measured at a frequency of 10 GHz) | | | | |
| Rate of resin fluidity (%) | 36 | 34 | 32 | 30 |
| Resin phase separation (Slice analysis) | No phase separation | No phase separation | No phase separation | No phase separation |

Formula information in Table 1:
Polyphenylene ether resin: SA-9000 (purchased from Sabic Company)
SBS resin: SBS (purchased from Japan Soda)
Novel low-dielectric resin: a styrene proportion of 10% to 40%; a Divinyl benzene proportion of 10% to 40%; an Ethylene proportion of 10% to 20%; Mn: 4500 to 6500
Cross-linking agent: triallyl isocyanuric acid
Halogen-free flame retardant: PQ-60 (purchased from Jinyi Chemical)
Synthetic silica: EQ2410-SMC (purchased from Sanshiji)
Peroxide: Luf
Siloxane coupling agent: siloxane compound

It may be seen from the above Table 1 that in Comparative example 1, the SBS resin is used instead of the conventional liquid rubber, so it has good fluidity and fillability and no phase separation occurring between the resins, and maintains the electrical specification of low-dielectric (the dielectric constant is 3.06 and the dissipation factor is 0.0018). Next, compared with Comparative Example 1, Examples 1-3 use the novel low-dielectric resin instead of the conventional liquid rubber, and an addition amount of the novel low-dielectric resin is about equal to the reduced proportion of the SBS resin. According to the evaluation result, as the addition amount of the novel low-dielectric resin increases, the dielectric constant and the dissipation factor may be reduced, and even the electrical specification of ultra-low-dielectric may be achieved (Example 3, with the dissipation factor of 0.0014) while hardly affecting fluidity and fillability of the resin composition at the same time.

To sum up, by using the novel low-dielectric resin instead of the liquid rubber, the resin composition of the disclosure may effectively reduce the dissipation factor and/or dielectric constant of the resin composition to achieve the electrical specification of low-dielectric while maintaining fluidity and fillability of the resin composition at the same time.

Although the disclosure has been described with reference to the embodiments above, the embodiments are not intended to limit the disclosure. Any person skilled in the art may make some changes and modifications without departing from the spirit and scope of the disclosure. Therefore, the scope of the disclosure will be defined in the appended claims.

What is claimed is:

1. A resin composition, comprising:
a novel low-dielectric resin, having a styrene proportion of 10% to 40%, a divinylbenzene proportion of 10% to 40%, and an ethylene proportion of 10% to 20%;
a cross-linking agent;
a polyphenylene ether resin;
a halogen-free flame retardant;
a spherical silica; and
a siloxane coupling agent.

2. The resin composition according to claim 1, wherein an addition amount of the novel low-dielectric resin is 10 wt % to 40 wt %, an addition amount of the cross-linking agent is 5 wt % to 25 wt %, an addition amount of the polyphenylene ether resin is 40 wt % to 60 wt %, and an addition amount of the spherical silica is 20 wt % to 50 wt %, based on a total weight of the resin composition.

3. The resin composition according to claim 1, wherein an addition amount of the halogen-free flame retardant is 20 phr to 50 phr, based on a total weight of the resin composition.

4. The resin composition according to claim 1, wherein an addition amount of the siloxane coupling agent is 0.1 phr to 5 phr, based on a total weight of the resin composition.

5. The resin composition according to claim 1, wherein a number average molecular weight of the novel low-dielectric resin is 4500 to 6000.

6. The resin composition according to claim 1, further comprising:
a SBS resin, having a styrene proportion of 10% to 40%, a 1,2 vinyl proportion of 60% to 90%, and a 1,4 vinyl proportion of 10% to 30%.

7. The resin composition according to claim 6, wherein an addition amount of the SBS resin is 0 wt % to 35 wt %, based on a total weight of the resin composition.

8. The resin composition according to claim 6, wherein a weight average molecular weight of the SBS resin is 3500 to 5500.

9. The resin composition according to claim 6, wherein an electrical specification of the resin composition is a dielectric constant of 3.02 to 3.04 and a dissipation factor of less than 0.0018.

10. The resin composition according to claim 1, wherein an electrical specification of the resin composition is a dielectric constant of 3.0 to 3.1 and a dissipation factor of less than 0.0015.
